(19) United States
(12) Patent Application Publication
(10) Pub. No.: US 2008/0100738 A1
(43) Pub. Date: May 1, 2008

(54) Focus detection device and accumulation control method of focus detection device

(75) Inventors: Hitoshi Tsuchiya, Tokyo (JP); Masato Osawa, Tokyo (JP); Kosei Tamiya, Sagamihara-shi (JP); Tatsuya Takei, Tokyo (JP); Mitsutomo Kariya, Tokyo (JP); Tetsuo Kikuchi, Tokyo (JP); Koichi Nakata, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/975,935

(22) Filed: Oct. 23, 2007

(30) Foreign Application Priority Data
Oct. 27, 2006 (JP) 2006-291946

(51) Int. Cl. G01J 1/42; G03B 13/00

(52) U.S. Cl. 348/345

(57) ABSTRACT

A focus detection device having a pair of light receiving sections (a first and second light receiving sections) which receive subject images observed from different view fields having parallax to accumulate charges is disclosed. The accumulation of the charges in the pair of light receiving sections is ended selectably based on an accumulation level of the charges at one light receiving section and an accumulation levels of the charges at both light receiving sections. Moreover/alternatively, the light receiving section has a plurality of light receiving units, and signals to end the accumulation of the charges at the respective light receiving units are sent to the first and second light receiving sections. In this case, a combination of the light receiving unit of the first light receiving section and the light receiving unit of the second light receiving section to which the signals are to be sent can be switched.

### CROSS-REFERENCE TO RELATED APPLICATION

This application is based upon and claims the benefit of priority from prior Japanese Patent Application No. 2006-291946, filed on Oct. 27, 2006, the entire contents of which are incorporated herein by reference.

### BACKGROUND OF THE INVENTION

1. Field of the Invention

This invention relates to a focus detection device. More particularly, it relates to a focus detection device capable of detecting focusing states of a plurality of focusing points in a photographing screen.

2. Description of the Related Art

In recent years, with sophistication of a performance and a function of a camera, a focus detection device capable of detecting focusing states of many focusing points in a photographing screen has been used. In the focus detection device constituted in this manner, when an AF optical system for focus detection and a focus detection area change, a focus detection device having a new constitution needs to be accordingly developed.

On the other hand, in Japanese Patent Application Laid-Open No. 2004-272238, a focus detection device capable of coping with different AF optical systems is disclosed. In the focus detection device, on the same circuit substrate, there are provided a plurality of line sensors; monitor sensors which are disposed adjacent to the respective line sensors and which monitor quantities of lights received by the adjacent line sensors; and control means for performing drive and control in arbitrary combinations of the line sensors and the monitor sensors.

### BRIEF SUMMARY OF THE INVENTION

A focus detection device of the present invention has a pair of light receiving sections which receive subject images observed from different view fields having parallax to accumulate charges. To end the accumulation of the charges at the pair of light receiving sections, the base of the end of the accumulation is selectable between an accumulation level of the charges at one of the light receiving sections and accumulation levels of the charges at both of the light receiving sections.

Moreover/alternatively, a focus detection device of the present invention has a pair of light receiving sections (a first light receiving section and a second light receiving section) which receive subject images observed from different view fields having parallax to accumulate charges, and the light receiving sections have a plurality of light receiving units, respectively. Signals to end the accumulation of the charges at the respective light receiving units are sent to the first light receiving section and the second light receiving section, but a combination of a light receiving unit of the first light receiving section and a light receiving unit of the second light receiving section to which the signals are to be sent can be switched.

One example of a constitution of the focus detection device according to the present invention can be described as follows. A focus detection device comprising: a pair of light receiving sections which receive subject images observed from different view fields having parallax to accumulate charges in accordance with quantities of received light; a pair of accumulation level generating sections which correspond to the pair of light receiving sections and which generate outputs indicating accumulation levels of the charges of the respective light receiving sections; and an accumulation control section which outputs an accumulation start signal and an accumulation end signal to the pair of light receiving sections to control accumulating operations, wherein the accumulation control section is constituted so that it is selectable between a case where the end of the accumulation is judged based on the output of one accumulation level generating section of the pair of accumulation level generating sections, and a case where the end of the accumulation is judged based on the outputs of both the accumulation level generating sections of the pair of accumulation level generating sections.

Another example of a constitution of the focus detection device according to the present invention can be described as follows. A focus detection device comprising: a pair of a first light receiving section and a second light receiving section as a pair of light receiving sections which receive subject images observed from different view fields having parallax to accumulate charges in accordance with quantities of received light, the first light receiving section and the second light receiving section including a plurality of light receiving units, respectively; an accumulation control section which outputs an accumulation start signal and a plurality of accumulation end signals to the light receiving units of the pair of light receiving sections to control accumulating operations; and a switch section which switches the plurality of accumulation end signals to the light receiving units of the second light receiving section to output the signals, wherein it is selectable between a constitution in which a first light receiving unit of the first light receiving section and a second light receiving unit of the second light receiving section are a pair of light receiving units and a constitution in which a third light receiving unit of the first light receiving section and the second light receiving unit of the second light receiving section are a pair of light receiving units, the accumulation control section outputs a first accumulation end signal to the first light receiving unit and the switch section and outputs a second accumulation end signal to the third light receiving unit and the switch section, and the switch section switches the first accumulation end signal and the second accumulation end signal to output the signal to the second light receiving unit.

Moreover, the present invention can be understood as the invention of an accumulation control method of the focus detection device.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a schematic block diagram showing a single lens reflex camera including a focus detection device according to the present invention;

FIG. 2 is a diagram schematically showing a constitution of a secondary image forming system portion of an AF optical system in the camera shown in FIG. 1;

FIG. 3A is a diagram showing a constitution of a sensor which detects focused states of eleven focusing points in an AF sensor shown in FIG. 1;

FIG. 3B is a diagram showing a constitution of a sensor which detects focused states of seven focusing points in the AF sensor shown in FIG. 1;

FIG. 4 is a diagram showing a constitution of the AF sensor arranged at each of the focusing points according to an embodiment of the focus detection device of the present invention;

FIG. 5 is a diagram showing a sensor circuit constitution of a part of a horizontal direction standard section line sensor unit and a horizontal direction reference section line sensor unit shown in FIG. 4;

FIG. 6 is a circuit constitution diagram showing a correspondence between line sensors which input accumulation stop signals from integral time control circuits of a part of the horizontal direction standard section line sensor unit and the horizontal direction reference section line sensor unit shown in FIG. 4;

FIG. 7 is a diagram showing a relation between an AF controller command and the integral time control circuit in a usual accumulation sequence of the AF sensor according to the present invention;

FIG. 8 is a diagram showing a relation between the AF controller command and the integral time control circuit in a forced accumulation end sequence;

FIG. 9 is a diagram showing a relation between the AF controller command and the integral time control circuit in an accumulation sequence in a case where an amplification factor is set to a second amplification circuit;

FIG. 10 is a diagram showing line sensors to be used and to be unused in a case where an optical system corresponding to eleven focusing points of the AF sensor shown in FIG. 4 is used;

FIG. 11 is a diagram showing line sensors to be used and to be unused in a case where an optical system corresponding to seven focusing points of the AF sensor shown in FIG. 4 is used; and

FIGS. 12A to 12D are diagrams showing a correspondence between standard section line sensors and reference section line sensors in a case where the optical systems corresponding to eleven focusing points and seven focusing points of the AF sensor shown in FIG. 4 are used.

### DETAILED DESCRIPTION OF THE PREFERRED EMBODIMENT

A preferred embodiment of the invention is described below with reference to the accompanying drawings.

The present embodiment of a focus detection device according to the present invention is constituted so as to cope with two different types of AF optical systems including an AF optical system having eleven focusing points and an AF optical system having seven focusing points. An automatic focusing mechanism of the whole camera will first be described.

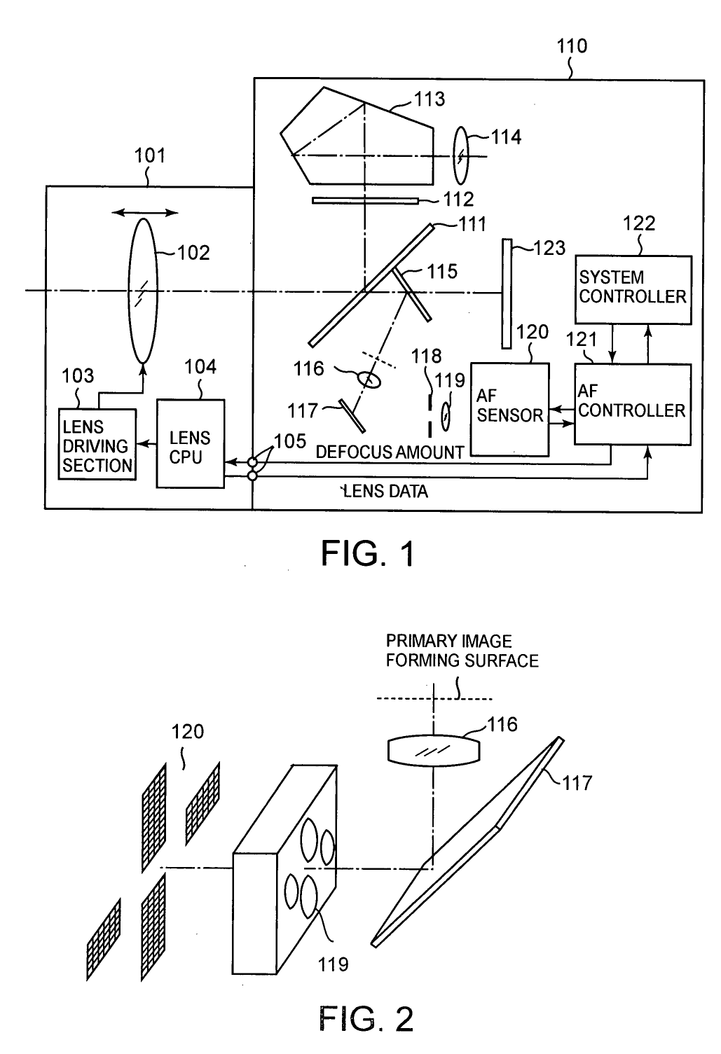

FIG. 1 is a schematic block diagram showing a lens-interchangeable single lens reflex camera including a focus detection device according to the present invention. This camera has an interchangeable lens 101 and a camera body 110. The interchangeable lens 101 is detachably attached to the camera body 110 via a camera mount (not shown) disposed at a front surface of the camera body 110. In this interchangeable lens 101, a focus lens 102, a lens driving section 103 and a lens CPU 104 are disposed.

The focus lens 102 is a lens for focusing included in a photographing optical system, and is driven in an optical axis direction (an arrow direction of FIG. 1) by a motor (not shown) disposed in the lens driving section 103. Here, an actual photographing optical system includes a plurality of lenses, but FIG. 1 shows the only focus lens 102. The lens driving section 103 includes a motor and a driving circuit (a motor driver) of the motor.

The lens CPU 104 is a control circuit which performs control of the lens driving section 103 and the like. This lens CPU 104 is constituted so as to communicate with an AF controller 121 disposed in the camera body 110 via a communication connector 105. From the lens CPU 104 to the AF controller 121, communication of lens data such as manufacturing fluctuation information of the focus lens and aberration information of the focus lens beforehand stored in the lens CPU 104 is performed.

Moreover, the camera body 110 is constituted as follows. A main mirror 111 is a rotatable mirror in which a middle portion is a half mirror. When the main mirror 111 is disposed at a downward position (a shown position), a part of a luminous flux from a subject (not shown), which has entered the camera body 110 via the focus lens 102 of the interchangeable lens 101, is reflected by the main mirror 111. This reflected light reaches an eyepiece lens 114 via a focusing screen 112 and a penta prism 113. In consequence, a state of the subject can be observed.

Furthermore, another part of the luminous flux which has entered the main mirror 111 passes through the half mirror portion, is reflected by a sub-mirror 115 installed on the back surface of the main mirror 111, and is guided into an AF optical system which performs automatic focus detection (AF). The AF optical system has a condenser lens 116, a total reflection mirror 117, a separator aperture stop 118 and a separator lens 119.

FIG. 2 is a diagram schematically showing a secondary image forming system of the AF optical system for use in the camera shown in FIG. 1. The luminous flux reflected by the sub-mirror 115 is formed into an image on a primary image forming surface. The luminous flux of the subject formed into the image on the primary image forming surface is condensed by the condenser lens 116 and reflected by the reflection mirror 117. The reflected light is pupil-divided by the separator aperture stop (not shown) at an exit pupil (not shown) of the interchangeable lens 101 which has a conjugate relation with respect to the separator aperture stop and a focal surface. The luminous flux of the subject pupil-divided by the separator aperture stop is condensed by the separator lens 119 to enter a predetermined area of an AF sensor 120 disposed behind the AF optical system.

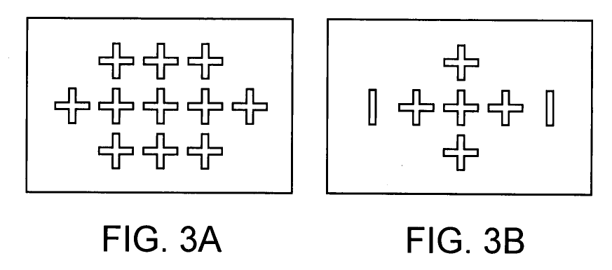

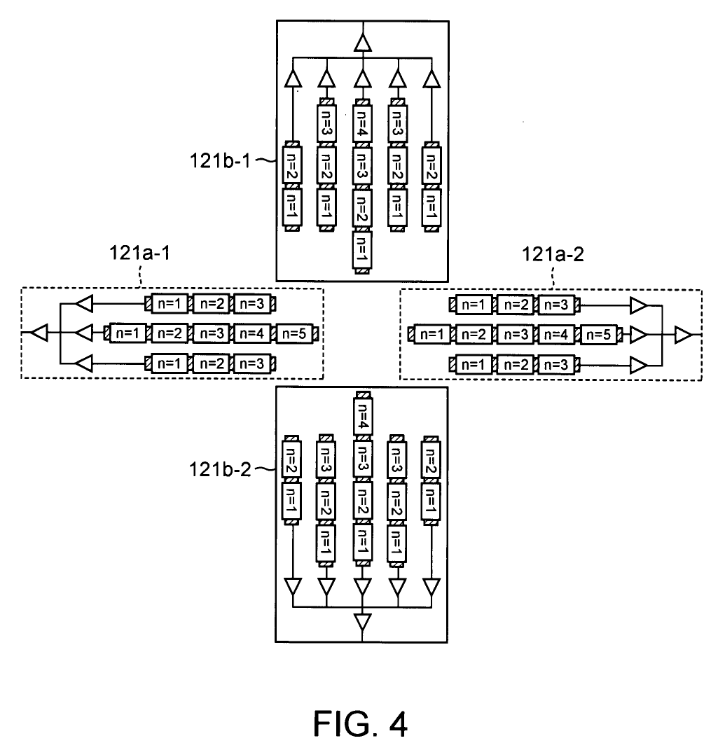

The AF sensor 120 copes with two types of AF optical systems including an AF optical system which forms a subject image corresponding to eleven focusing points on a photographing screen as shown in FIG. 3A and an AF optical system which forms a subject image corresponding to seven focusing points on a photographing screen as shown in FIG. 3B. The AF sensor 120 can detect focused states of the focusing points.

These tow types of AF optical systems are brought owing to differences of characteristics of the condenser lens 116 and the separator lens 119. A constitution of the AF sensor 120 will be described later in detail.

In the AF sensor 120, the luminous flux from the subject is converted into an analog electric signal by photoelectric conversion. An output of the AF sensor 120 is input into the AF controller 121. The AF controller 121 controls the start and end of accumulation, and reading with respect to the AF sensor 120, and calculates a defocus amount based on an input from the AF sensor 120. An operation of this AF controller 121 is controlled by a system controller 122.

Moreover, the defocus amount obtained by the AF controller 121 is transmitted to the lens CPU 104. The lens CPU 104 calculates a motor driving amount for driving the focus lens 102 based on the received defocus amount. Focusing of the focus lens 102 is driven via the lens driving section 103 based on this motor driving amount.

Furthermore, in FIG. 1, when the main mirror 111 retreats from an optical path of the focus lens 102 and is disposed at an upward position, the luminous flux from the subject which has struck via the focus lens 102 forms an image on an image pickup device 123 and is photoelectrically converted. In consequence, the resultant image pickup signal is input into the system controller 122, subjected to predetermined image processing, and recorded in a recording medium (not shown).

Next, a detailed constitution of the AF sensor which is the focus detection device according to the present invention will be described. FIG. 4 is a diagram showing a configuration of sensors arranged at measurement points in order to detect two types of focusing states of eleven focusing points of FIG. 3A and seven focusing points of FIG. 3B. The AF sensor shown in FIG. 4 has a horizontal direction standard section sensor unit 121a-1 and a horizontal direction reference section sensor unit 121a-2 arranged along a horizontal direction of the photographing screen, and a vertical direction standard section sensor unit 121b-1 and a vertical direction reference section sensor unit 121b-2 arranged along a vertical direction of the photographing screen. It is to be noted that the horizontal direction standard section sensor unit 121a-1 and the horizontal direction reference section sensor unit 121a-2 form a pair. The vertical direction standard section sensor unit 121b-1 and the vertical direction reference section sensor unit 121b-2 forma a pair. The respective pairs of sensor units calculate the defocus amounts.

Here, each of the horizontal direction standard section sensor unit 121a-1 and the horizontal direction reference section sensor unit 121a-2 includes rows of eleven pixels including one row of line sensors which consists of a row of five pixels and two rows of line sensors each of which consists of a row of three pixels.

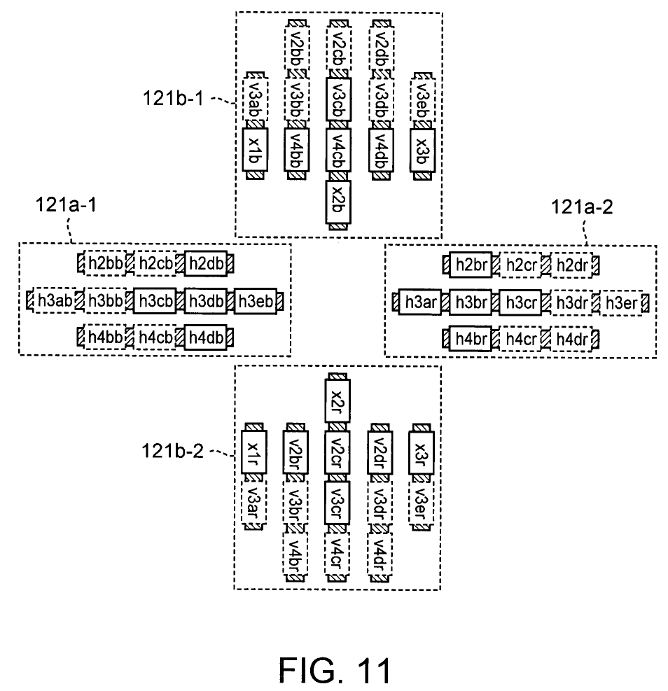

In each of the vertical direction standard section sensor unit 121b-1 and the vertical direction reference section sensor unit 121b-2, two rows of line sensors each of which consists of a row of three pixels, two rows of line sensors each of which consists of a row of two pixels, and one row of line sensors which consists of a row of four pixels are arranged. Each of the vertical direction sensor units includes the rows of 14 pixels. A reason why the number of the pixels of the rows of each of the vertical direction sensor units is larger than eleven is that there are pixel rows for exclusive use in focusing of seven points (x2b, x2r of FIG. 11).

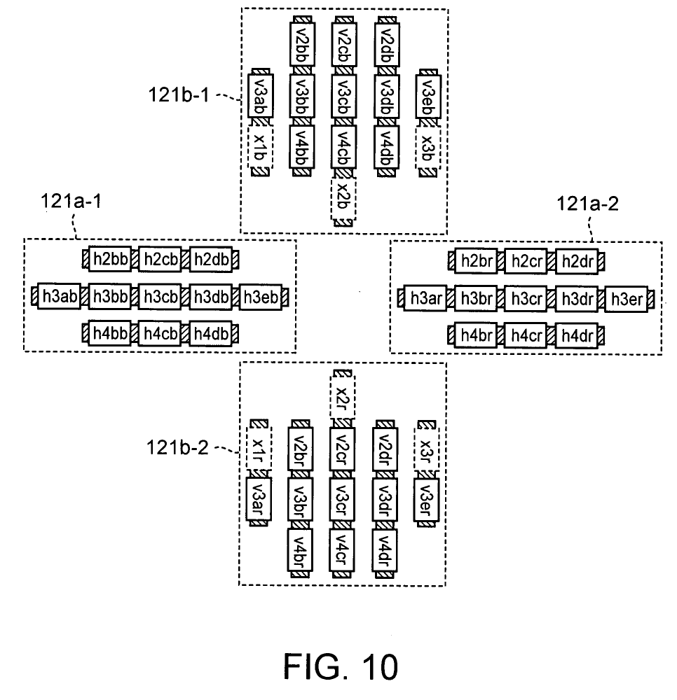

In a case where there are eleven focusing points as shown in FIG. 3A, eleven rows of pixels (line sensors) are used in each of the horizontal direction standard section sensor unit 121a-1, the horizontal direction reference section sensor unit 121a-2, the vertical direction standard section sensor unit 121b-1 and the vertical direction reference section sensor unit 121b-2. In a case where there are seven focusing points as shown in FIG. 3B, five rows of pixels (line sensors) are used in each of the horizontal direction standard section sensor unit 121a-1 and the horizontal direction reference section sensor unit 121a-2, and seven rows of pixels (line sensors) are used in each of the vertical direction standard section sensor unit 121b-1 and the vertical direction reference section sensor unit 121b-2. Correspondences of the rows of the pixels for use at the respective focusing points will be described later in detail with reference to FIGS. 10, 11 and 12.

According to such a constitution, all of the focused states at all of the eleven or seven focusing points shown in FIG. 3A or 3B can be detected using two pairs of sensor units including the horizontal direction sensor units and the vertical direction sensor units. Therefore, precision of focus detection can be improved. In addition, in the case of using the seven focusing points, as shown in FIG. 3B, the focusing points of the left and right ends are detected using the only vertical direction sensor units.

Moreover, as shown in FIG. 4, output sections are constituted so that outputs from the pixel rows of a standard section of each pair of sensor units in the horizontal direction or the vertical direction are successively emitted toward a side opposite to a side on which the pixel rows of a reference section are arranged, that is, the output sections are directed toward a side on which any pixel row of the reference section does not exist. Similarly, another output sections are constituted so that outputs from the pixel rows of the reference section are successively emitted toward a side opposite to a side on which the pixel rows of the standard section are arranged.

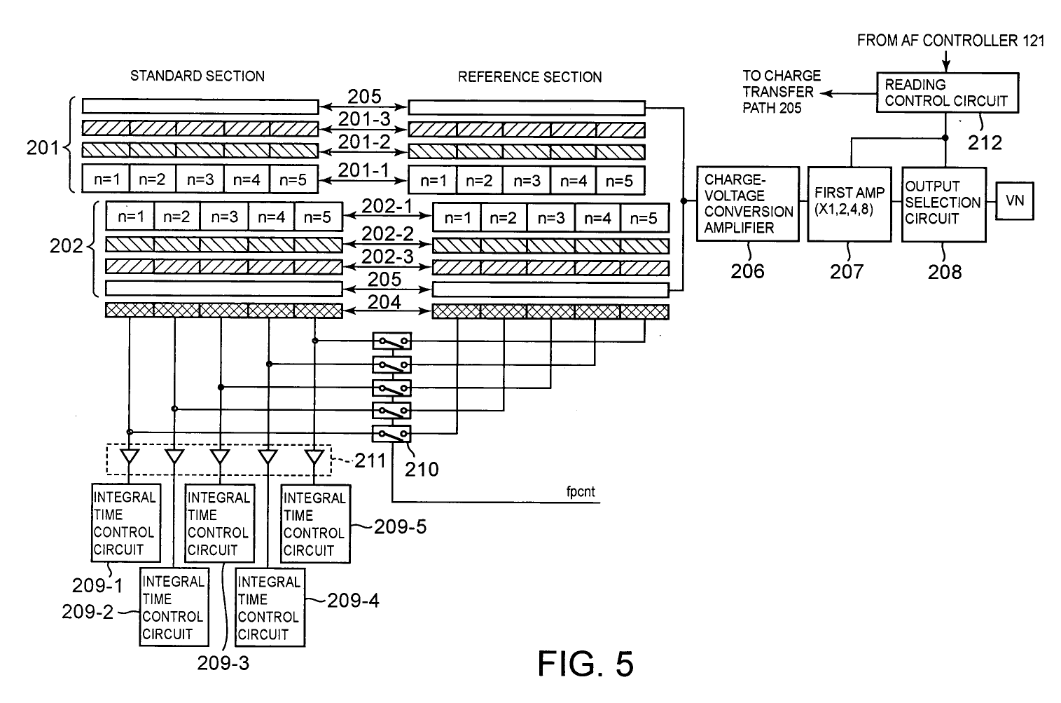

FIG. 5 is a diagram showing a sensor circuit constitution of a part (a line sensor part including the row of five pixels) extracted from the horizontal direction standard section sensor unit 121a-1 and the horizontal direction reference section sensor unit 121a-2. Here, n shown in FIG. 5 corresponds to n of FIG. 4. It is to be noted that in FIG. 4, a sensor circuit constitution of a part other than the part shown in FIG. 5 is the same as that of FIG. 5 except that the number of the pixel rows differs.

As shown in FIG. 5, in the present embodiment, corresponding to one pixel row, two line sensors 201, 202 provided to deviate each other in a transverse direction. That is, the line sensor 202 is displaced from the line sensor 201 as much as ½ pixel of the row and is arranged, and calculation of one pixel row is performed using outputs from both outputs of two line sensors 201, 202. In consequence, the precision of the focus detection can be improved.

Moreover, as shown in FIG. 5, along and beside the second line sensor 202, photodiodes 204 for monitoring is arranged, the photodiodes 204 are divided in accordance with each pixel row (n=1 to 5).

The two line sensors 201, 202 constituting the respective pixel rows have a plurality of photodiodes 201-1, 202-1 constituting pixels, respectively. In these plurality of photodiodes 201-1, 202-1, light charges are obtained in accordance with a quantity of a subject luminous flux which has struck on the photodiodes 201-1, 202-1. The light charges obtained in the respective photodiodes 201-1, 202-1 are accumulated in charge accumulating sections 201-2, 202-2.

Here, charge accumulation amounts of the charge accumulating sections 201-2, 202-2 are monitored by the photodiodes 204 for monitoring. The photodiodes 204 for monitoring are two photodiodes of photodiodes 204 for monitoring the standard section and the photodiodes 204 for monitoring the reference section corresponding to the photodiode 204 for monitoring the standard section. When a switch 210 is switched, either an average value of outputs corresponding to the respective pixel rows of the two types of photodiodes 204 for monitoring or an output of one pixel row of the photodiodes 204 for monitoring the standard section is selected.

The selected output is amplified at a predetermined amplification factor by a second amplification circuit 211, and output to integral time control circuits 209-1 to 209-5. The integral time control circuits 209-1 to 209-5 are arranged so as to correspond to the pixel rows of the photodiodes 204 for monitoring. It is judged whether or not the outputs of the photodiodes 204 for monitoring, which is amplified at the predetermined amplification factor and input into the integral time control circuits 209-1 to 209-5, are a predetermined threshold value. When the outputs indicate the threshold value or more, an integrating operation of accumulating the light charges generated in the photodiodes 201-1, 202-1 of the line sensors into the charge accumulating sections 201-2, 202-2 is ended. Even in a case where the outputs of the photodiodes 204 for monitoring do not indicate the predetermined threshold value or more, when an accumulation end command from the AF controller 121 is received, the charge accumulation is ended. It is to be noted that the threshold value for ending the charge accumulation and an integral time can be changed by the AF controller 121.

The switch 210 switches whether to validate or invalidate the outputs from the photodiodes 204 for monitoring the reference section. The switching is selected in accordance with a difference of the AF optical system. The switching is performed in response to a signal fpcnt shown in FIG. 5. The switch 210 is controlled so as to validate the outputs (turn on the switch 210) in the case of eleven focusing points and invalidate the outputs (turn off the switch 210) in the case of seven focusing points. When the switch 210 is switched to be valid, as an accumulation level, the average value of the outputs of the photodiodes 204 for monitoring the standard section and the reference section is input into the integral time control circuits 209-1 to 209-5. When the switch 210 is switched to be invalid, as the accumulation level, the only output values of the photodiodes 204 for monitoring the standard section are input into the integral time control circuits 209-1 to 209-5.

When the charge accumulation ends, transfer switches 201-3, 202-3 connected to a subsequent stage of the charge accumulating sections 201-2, 202-2 are closed, and the light charges accumulated in the charge accumulating sections 201-2, 202-2 are transferred to charge transfer paths 205.

On receiving a CCD reading command from the AF controller 121, a reading control circuit 212 applies strings of pulses to the charge transfer paths 205. In response to each of these pulses, the light charges are shifted toward a charge-voltage conversion amplifier 206 in the charge transfer paths 205, transferred one pixel at a time to the charge-voltage conversion amplifier 206, and converted into voltage signals. The voltage signal converted by the charge-voltage conversion amplifier 206 is amplified at a predetermined amplification factor (e.g., selected from one of 1, 2, 4 and 8) by a first amplification circuit 207, and then input into an output selection circuit 208.

Here, the amplification factor of the first amplification circuit 207 is determined by the reading control circuit 212 based on the amplification factor of the second amplification circuit 211. As described above, the second amplification circuit 211 amplifies the outputs of the photodiodes 204 for monitoring corresponding to the pixel rows in which the output charges are accumulated.

The output selection circuit 208 is controlled by the reading control circuit 212. The output selection circuit 208 selects and outputs a predetermined voltage (a voltage in which the selected sensor row output is amplified by the first amplification circuit 207) from the outputs of all the sensor rows including the photodiodes 201-1, 202-1 which are the sensor rows and another sensor row (not shown). In consequence, the resultant output voltage VN is output to the subsequent-stage AF controller 121.

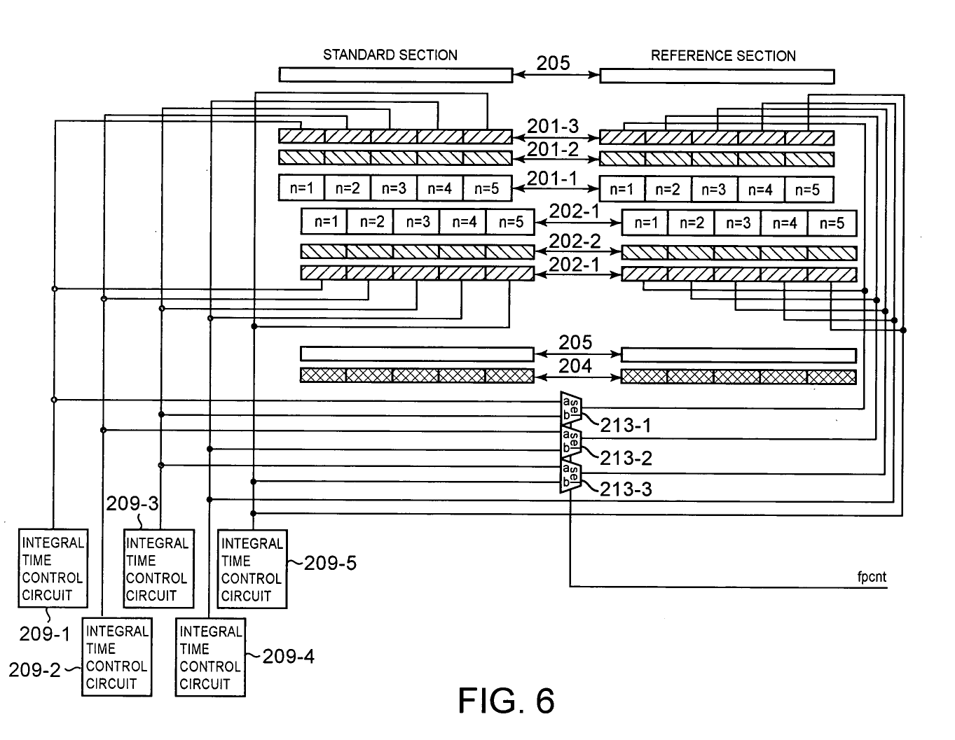

FIG. 6 is a circuit constitution diagram showing a correspondence between the line sensor 201 and the line sensor 202. The line sensors 201, 202 input accumulation end signals from the integral time control circuits 209-1 to 209-5 of a part of the horizontal direction standard section sensor unit 121a-1 and the horizontal direction reference section sensor unit 121a-2 shown in FIG. 4.

In a state in which the accumulation is to be ended, the integral time control circuits 209-1 to 209-5 output the accumulation end signals to the corresponding line sensors 201, 202. At the end of the accumulation, the corresponding transfer switches 201-3, 202-3 of the line sensors 201, 202 are closed, and the light charges accumulated in the corresponding charge accumulating sections 201-2, 202-2 are transferred to the charge transfer paths 205.

Each of selectors 213-1 to 213-3 switches the accumulation end signal from two corresponding circuits of the integral time control circuits 209-1 to 209-5 to the reference section sensor unit according to number of the focusing points (seven or eleven) so that the accumulation end signal is output to the predetermined line sensors 201, 202 of the reference section sensor unit. This switching by the selectors 213-1 to 213-3 is controlled in response to the fpcnt signal by the AF optical system. In the case of the eleven focusing points, the selectors are switched to a, and all the accumulation end signals from the integral time control circuits 209-1 to 209-5 are input into the photodiodes constituting each pixels of the line sensors 201, 202 of the reference section sensor unit. In the case of the seven focusing points, the selectors are switched to b, and the accumulation end signals from the three integral time control circuits 209-3 to 209-5 are input into three photodiodes (n=1 to 3) of the line sensors 201, 202 of the reference section sensor unit.

Another constitution that is not shown in FIG. 6 is the same as the constitution of FIG. 5. Constitutions of another line sensor portion of the standard section sensor unit and the reference section sensor unit in the horizontal direction and another line sensor part of the standard section sensor unit and the reference section sensor unit in the vertical direction are also the same to those of FIGS. 5 and 6.

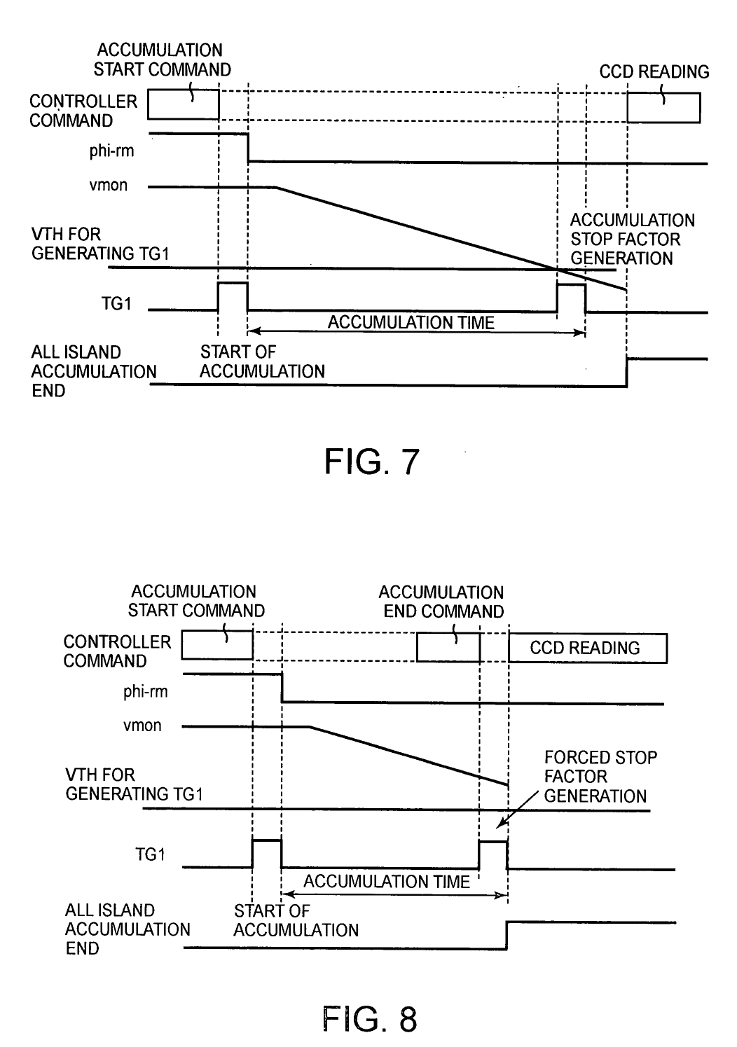

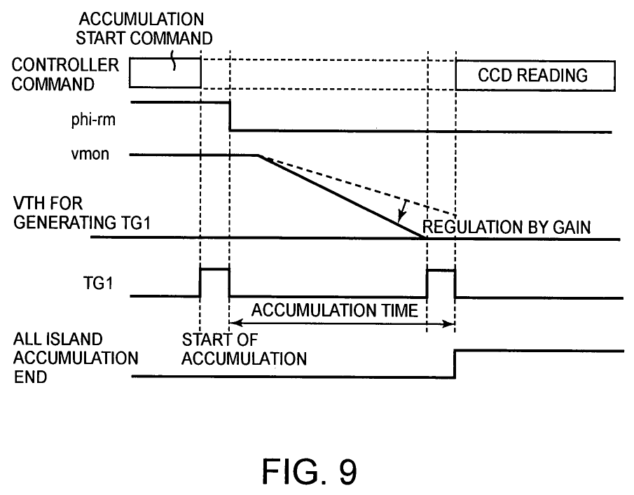

FIGS. 7 to 9 showing a relation between a command from the AF controller 121 and operations of the integral time control circuits 209-1 to 209-5. FIG. 7 is a diagram showing a usual sequence, FIG. 8 is a diagram showing a forced accumulation end sequence (the accumulation ends at a predetermined time), and FIG. 9 is a diagram showing an accumulation sequence in a case where the amplification factor is set to the second amplification circuit 211, respectively. In the drawings, phi-rm is a signal to discharge the charges accumulated in the charge accumulating sections 201-2, 202-2, and the charges are discharged at a high level. In the drawings, vmon is a signal (an output of the second amplification circuit 211 shown in FIG. 5) output from the photodiode 204 for monitoring, amplified at a predetermined amplification factor by the second amplification circuit 211, input into the integral time control circuits 209-1 to 209-5 and monitored.

In the drawings, TG1 is an accumulation control signal, and means the start of the accumulation in a case where the pulse is input simultaneously with the end of the discharging of the charges. When the pulse of TG1 indicating the start of the accumulation is input, the light charges photoelectrically converted by the photodiodes 201-1, 202-1 are accumulated in the charge accumulating sections 201-2, 202-2. The second TG1 pulse (a pulse input at a time when phi-rm indicates a low level) means the end of the accumulation. When the second TG1 pulse indicating the end of the accumulation is input, the light charges accumulated in the charge accumulating sections 201-2, 202-2 are transferred to the charge transfer paths 205.

Here, as shown in FIG. 7, in the usual accumulation sequence, the second TG1 pulse is generated because vmon exceeds VTH (a threshold value) for generating TG1. On the other hand, to forcedly end the accumulation, as shown in FIG. 8, the second TG1 pulse is generated in response to an accumulation end command from the AF controller 121.

In the accumulation sequence shown in FIG. 9, when the predetermined amplification factor is set to the second amplification circuit 211, the outputs from the photodiodes 204 for monitoring are amplified, and a time required for vmon to reach VTH for generating TG1 is reduced.

In the present embodiment, different AF optical systems which can be handled will be described. The AF optical system for eleven points is different from that for seven points in a base length which is a space between divided pupils and which is concerned with the precision of the focus detection. The base length for seven points is set to be shorter than that for eleven points. It is known that the focus detection precision increases, as the base length increases. A usable area of the photographing screen (on an AF sensor surface) where a performance is optically ensured for the seven points is set to be smaller than that for eleven points. When the base length is reduced and a usable region is reduced in this manner, the AF optical system can be miniaturized.

FIG. 10 shows sensor units of the standard section and the reference section in the horizontal direction and the vertical direction among the AF sensors arranged at the respective focusing points in a case where the AF optical system corresponding to the eleven focusing points is used. The line sensors for use are shown in solid lines, and line sensors x1b, x2b, x3b, x1r, x2r and x3r of the vertical direction sensor units shown in broken lines are line sensors which are not to be used.

FIG. 11 shows a case where the AF optical system for the seven focusing points is used. The line sensors for use are shown in solid lines, and line sensors h2bb, h2cb, h3ab, h3bb, h4bb, h4cb, h2cr, h2dr, h3dr, h3er, h4cr, h4dr, v3ab, v2bb, v3bb, v2cb, v2db, v3db, v3eb, v3ar, v3br, v4br, v4cr, v3dr, v4dr and v3er shown in broken lines are line sensors which are not to be used.

The line sensors corresponding to the base length are v3cb and v3cr of the vertical direction in the AF optical system for the eleven points, and a space between the sensors is the base length. In the horizontal direction, a space between h3cb and h3cr corresponds to the base length. In the AF optical system for the seven points, in the vertical direction, a space between v4cb and v2cr corresponds to the base length. In the horizontal direction, a space between h3db and h3br corresponds to the base length.

Moreover, in the respective AF optical system, it is assumed that the line sensors included in the usable area where the performance is optically ensured are usable line sensors.

It is to be noted that the constitution of the line sensors shown in FIG. 6 shows a configuration corresponds to the selection switching of whether or not to use the line sensors of the rows each of five pixels in the horizontal direction sensor units of the AF sensors shown in FIGS. 10 and 11.

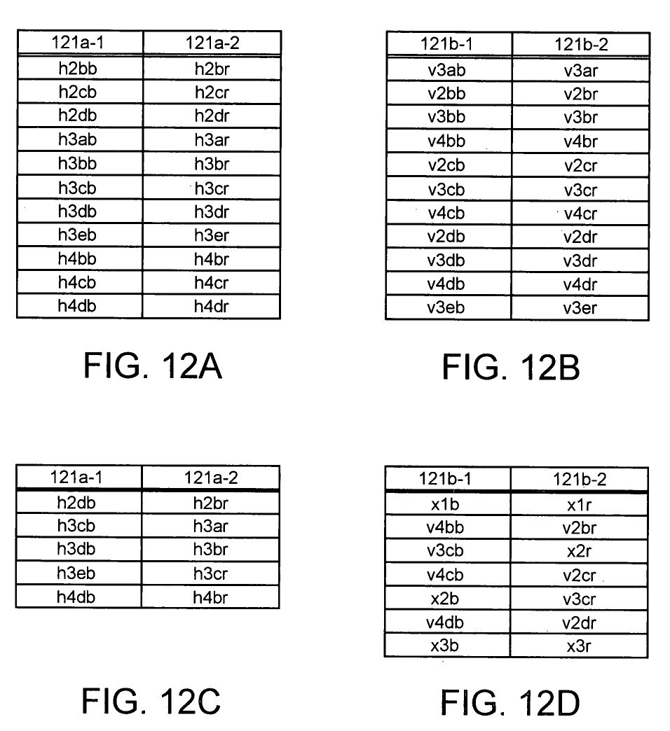

FIGS. 12A to 12D are tables showing correspondences between the standard section line sensors and the reference section line sensors in a corresponding operation of each AF optical system. FIG. 12A shows a correspondence between the line sensors of the standard section and the reference section of the horizontal direction in the case of the eleven focusing points. FIG. 12B shows a correspondence between the line sensors of the standard section and the reference section of the vertical direction in the case of the eleven focusing points. FIG. 12C shows a correspondence between the line sensors of the standard section and the reference section of the horizontal direction in the case of the seven focusing points. FIG. 12D shows a correspondence between the line sensors of the standard section and the reference section of the vertical direction in the case of the seven focusing points.

As described above, according to the present invention, by providing the switch 210, the charge accumulated state can be detected using the only photodiodes 204 for monitoring the standard section. In this case, the detection is not influenced by the correspondence between the line sensors of the standard section and the reference section, and hence the accumulated state which does not depend on the AF optical system can be detected. Furthermore, by switching accumulation stop controls of the line sensors of the reference section, a plurality of different AF optical systems can be handled with a comparatively small-sized circuit.

Moreover, even in the present embodiment, the number of the focusing points is not limited to eleven points and the seven points, and the corresponding AF optical systems are not limited to two types.

In the present embodiment, the line sensors 201, 202 form a set, and one set on a standard side and one set on a reference side form a pair. These line sensors 201, 202 receive subject images observed from different view fields having parallax to accumulate the charges in accordance with quantities of received light, and can be referred to as a pair of light receiving sections. The line sensors 201, 202 have a plurality of pixel rows, and the pixel rows can be referred to as light receiving units. The photodiodes 204 for monitoring form a pair, correspond to a pair of line sensors and generate outputs indicating accumulation levels of the charges. Therefore, the photodiodes can be referred to as a pair of accumulation level generating section. The accumulation level section integral time control circuits 209-1 to 209-5 output the accumulation start signal and the accumulation end signal to a pair of line sensors to control the accumulating operation, and can therefore be referred to as accumulation control sections. The selectors 213-1 to 213-3 switch and output a plurality of accumulation end signals from the accumulation level section integral time control circuits 209-3 to 209-5 to the pixel rows of the line sensors on the reference side, and can therefore be referred to as switching sections.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims,

What is claimed is:

1. A focus detection device comprising:
a pair of light receiving sections which receive subject images observed from different view fields having parallax to accumulate charges in accordance with quantities of received light;
a pair of accumulation level generating sections which correspond to the pair of light receiving sections and which generate outputs indicating accumulation levels of the charges of the respective light receiving sections; and
an accumulation control section which outputs an accumulation start signal and an accumulation end signal to the pair of light receiving sections to control accumulating operations,
wherein the accumulation control section is constituted so that it is selectable between a case where the end of the accumulation is judged based on the output of one accumulation level generating section of the pair of accumulation level generating sections, and a case where the end of the accumulation is judged based on the outputs of both the accumulation level generating sections of the pair of accumulation level generating sections.

2. The focus detection device according to claim 1, wherein the focus detection device has a plurality of blocks each including the pair of light receiving sections, the pair of accumulation level generating sections and the accumulation control section.

3. The focus detection device according to claim 1, wherein in case where the accumulation control section judges the end of the accumulation based on the outputs of both the accumulation level generating sections of the pair of accumulation level generating sections, the accumulation control section judges the end of the accumulation based on an average value of the outputs of the pair of accumulation level generating sections.

4. The focus detection device according to claim 1, wherein the accumulation control section selects, based on a signal from the outside, the case where the end of the accumulation is judged based on the output of the one accumulation level generating section of the pair of accumulation level generating sections and the case where the end of the accumulation is judged based on the outputs of both the accumulation level generating sections of the pair of accumulation level generating sections.

5. A focus detection device comprising:
a pair of a first light receiving section and a second light receiving section as a pair of light receiving sections which receive subject images observed from different view fields having parallax to accumulate charges in accordance with quantities of received light, the first light receiving section and the second light receiving section including a plurality of light receiving units, respectively;
an accumulation control section which outputs an accumulation start signal and a plurality of accumulation end signals to the light receiving units of the pair of light receiving sections to control accumulating operations; and
a switch section which switches the plurality of accumulation end signals to the light receiving units of the second light receiving section to output the signals,
wherein it is selectable between a constitution in which a first light receiving unit of the first light receiving section and a second light receiving unit of the second light receiving section are a pair of light receiving units and a constitution in which a third light receiving unit of the first light receiving section and the second light receiving unit of the second light receiving section are a pair of light receiving units,
the accumulation control section outputs a first accumulation end signal to the first light receiving unit and the switch section and outputs a second accumulation end signal to the third light receiving unit and the switch section, and
the switch section switches the first accumulation end signal and the second accumulation end signal to output the signal to the second light receiving unit.

6. The focus detection device according to claim 5, wherein the focus detection device has a plurality of blocks each including the pair of light receiving sections, the accumulation control section and the switch section.

7. The focus detection device according to claim 5, which further comprises:
a pair of accumulation level generating sections which correspond to the pair of light receiving sections and which generate outputs indicating accumulation levels of the charges of the respective light receiving sections,
wherein the accumulation control section outputs the first accumulation end signal and the second accumulation end signal based on the outputs of the pair of accumulation level generating sections.

8. The focus detection device according to claim 5, wherein the switch section switches the first accumulation end signal and the second accumulation end signal in response to a signal input from the outside to output the signal to the second light receiving unit.

9. An accumulation control method of a focus detection device which receives a pair of luminous fluxes from a subject observed from different view fields having parallax and which outputs a pair of accumulation levels of charges in accordance with quantities of respective received light, the method comprising:
selecting between a case where the end of the accumulation is judged based on one accumulation level of the pair of accumulation levels and a case where the end of the accumulation is judged based on both accumulation levels of the pair of accumulation levels; and
controlling accumulating operations at the start and end of the accumulation with respect to the pair of luminous fluxes.

10. The accumulation control method of the focus detection device according to claim 9, wherein in the case where the end of the accumulation is judged based on both the outputs of the pair of accumulation levels, the end of the accumulation is judged based on an average value of the pair of accumulation levels.

11. An accumulation control method of a focus detection device having a first light receiving section and a second light receiving section as a pair of light receiving sections which receive subject images observed from different view fields having parallax to accumulate charges in accordance with quantities of received light, the method comprising:
switching between a case where a first accumulation end signal is output to a first light receiving unit of the first light receiving section and a second light receiving unit of the second light receiving section to constitute the first light receiving unit and the second light receiving unit as the pair of light receiving sections, and a case where a second accumulation end signal is output to a third light receiving unit of the first light receiving section and the second light receiving unit of the second light receiving section to constitute the third light receiving unit and the second light receiving unit as the pair of light receiving sections.

12. A focus detection device comprising:
a pair of line sensors which receive subject images observed from different view fields having parallax to accumulate charges in accordance with quantities of received light;
a pair of accumulation level generating circuits which correspond to the pair of line sensors and which generate outputs indicating respective accumulation levels of the charges; and
an accumulation control circuit which outputs an accumulation start signal and an accumulation end signal to the pair of line sensors to control accumulating operations, wherein the accumulation control circuit is constituted so that it is selectable between a case where the end of the accumulation is judged based on the output of one accumulation level generating circuit of the pair of accumulation level generating circuits, and a case where the end of the accumulation is judged based on the outputs of both the accumulation level generating circuits of the pair of accumulation level generating circuits.

13. The focus detection device according to claim 12, wherein in case where the accumulation control circuit judges the end of the accumulation based on the outputs of both the accumulation level generating circuits of the pair of accumulation level generating circuits, the end of the accumulation is judged based on an average value of the outputs of the pair of accumulation level generating circuits.

14. A focus detection device comprising:
a pair of a first line sensor and a second line sensor as a pair of line sensors which receive subject images observed from different view fields having parallax to accumulate charges in accordance with quantities of received light,
the first line sensor and the second line sensor including a plurality of light receiving units, respectively;
an accumulation control circuit which outputs an accumulation start signal and a plurality of accumulation end signals to the light receiving units of the pair of line sensors to control accumulating operations; and
a switch circuit which switches the plurality of accumulation end signals to the light receiving units of the second line sensor,
wherein it is selectable between a constitution in which a first light receiving unit of the first line sensor and a second light receiving unit of the second line sensor are the pair of light receiving units and a constitution in which a third light receiving unit of the first line sensor and the second light receiving unit of the second line sensor are the pair of light receiving units are selected,
the accumulation control circuit outputs a first accumulation end signal to the first light receiving unit and the switch section and outputs a second accumulation end signal to the third light receiving unit and the switch circuit, and
the switch circuit switches the first accumulation end signal and the second accumulation end signal to output the signal to the second light receiving unit.

15. The focus detection device according to claim 14, wherein the focus detection device has a plurality of blocks each including the pair of line sensors, the accumulation control circuit and the switch circuit.

16. The focus detection device according to claim 14, which further comprises:
a pair of accumulation level generation circuits which correspond to the pair of line sensors and which generate outputs indicating respective accumulation levels,
wherein the accumulation control circuit outputs the first accumulation end signal and the second accumulation end signal based on the outputs of the pair of accumulation level generation circuits.

17. The focus detection device according to claim 14, wherein the switch circuit switches the first accumulation end signal and the second accumulation end signal in response to a signal input from the outside to output the signal to the second light receiving section.
